(19) United States
(12) Patent Application Publication
(10) Pub. No.: US 2009/0183931 A1
(43) Pub. Date: Jul. 23, 2009

(54) TOUCH PANEL DEVICE

(75) Inventors: Yuichi OKANO, Tokyo (JP); Takenori Kawamata, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/165,947

(22) Filed: Jul. 1, 2008

(30) Foreign Application Priority Data
Jan. 21, 2008 (JP) 2008-010643

(51) Int. Cl. G06F 3/041

(52) U.S. Cl. 178/18.03

(57) ABSTRACT

A touch panel unit includes a plurality of electrodes arranged in directions of an X axis and a Y axis. A screening electrode switching control circuit handles each of electrodes arranged in the direction of the X axis as a detecting electrode and handles electrodes arranged in the direction of the Y axis as screening electrodes when an arithmetic unit detects the location of an approach or a touch to or with the touch panel unit in the direction of the X axis, whereas the screening electrode switching control circuit handles the electrodes arranged in the direction of the X axis as the screening electrodes and handles each of the electrodes arranged in the direction of the Y axis as the detecting electrode when the arithmetic unit detects the location of the approach or the touch to or with the touch panel unit in the direction of the Y axis.

### BACKGROUND OF THE INVENTION

1. Field of the Invention

The present invention relates to a touch panel device via which information can be inputted by using an input means, such as a finger. More particularly, it relates to a touch panel device which, in a capacitance touch panel of matrix type in which electrodes for detecting a location in an X-direction and a location in a Y-direction are arranged in the form of a matrix, can detect that a conductor, such as a finger, approaches thereto.

2. Description of Related Art

Touch-sensitive input devices of display integrated type have become to be utilized in various fields by virtue of downsizing of the devices, etc. Conventionally, touch panels of various types for detecting an input using a finger or a pen have been put to practical use. Among those touch panels of various types, a touch panel which is called a touch panel of capacitance type makes a weak current flow through a touch panel face so as to generate an electric field, converts a change in its capacitance value which occurs when a conductive material, such as a finger, has a touch therewith lightly into a reduction or the like in a voltage, so as to detect the change in the capacitance value, and then detects the location of the touch.

Furthermore, there has been provided a touch panel of matrix type as a touch panel of type of detecting two-dimensional location coordinates of an input means, such as a finger. In this type of touch panel, electrodes for detecting the location of the input means in an X-direction and electrodes for detecting the location of the input means in a Y-direction are arranged in such a way that they are shaped into rectangular slices and the X-direction electrodes and the Y-direction electrodes are perpendicular to each other. For example, patent reference 1 discloses an information input device, i.e., a touch panel which uses a capacitive sensing method of matrix type.

Because such a touch panel device of capacitive sensing type needs to detect a small change in the capacitance, the detection accuracy may degrade under the influence of surrounding conductive materials. More specifically, because, when there exists a conductive material other than a finger used for making an input via the coordinates input device, unnecessary electrostatic coupling (a stray capacity) occurs between the conductive material and an electrode line arranged in the coordinates input device and a current flows through the unnecessary electrostatic coupling, there is a possibility that the detection sensitivity of a reduction in a voltage which is caused by a touch by the finger which has to be detected by an output unit decreases.

On the other hand, there is an in-phase shield for suppressing such a stray capacity which is caused by an external factor. For example, patent reference 2 discloses a proximity sensor of capacitance type in which an in-phase shield pattern is arranged, as a sensor, under the surfaces of electrodes so as to stabilize the detection accuracy.
[Patent reference 1] JP, 7-129321, A
[Patent reference 2] JP, 7-29467, A

A problem with an information input device using the conventional above-mentioned capacitance touch panel of the matrix type is that it detects a change in the capacitance coupling between a fingertip and a Y-axis electrode line when detecting a Y-coordinate location, though capacitance coupling occurs between the Y-axis electrode line and an X-axis electrode line which is perpendicular to other Y-axis electrode lines which are unrelated to the detection of the Y-coordinate location because the X-axis electrode line is a conductive material, and the capacitance coupling may serve as a stray capacity and reduce the sensitivity of the detection of the location of the fingertip using the Y-axis electrode lines.

On the other hand, a problem with the conventional proximity sensor of capacitance type, as described in patent reference 2, which uses in-phase screening electrodes having the same potential as that of detecting electrodes to reduce the influence of external conductive materials is that the in-phase screening electrodes used for shielding must be newly disposed in addition to the detecting electrodes.

### SUMMARY OF THE INVENTION

The present invention is made in order to solve the above-mentioned problems, and it is therefore an object of the present invention to provide a touch panel device having improved sensitivity of detection of a touch by an input means, such as a finger.

In accordance with the present invention, there is provided a touch panel device including: a touch panel unit in which a plurality of electrodes are arranged; an arithmetic circuit for detecting a change in capacitance of one of the electrodes resulting from an approach or a touch of an input means to or with the touch panel unit, and detects a location of the approach or the touch; and a screening electrode switching control circuit for establishing an electrode connection in such a way that a part of the plurality of electrodes serves as detecting electrodes, and a remaining part of the plurality of electrodes serves as screening electrodes and has a same potential as that of the detecting electrodes.

Because the touch panel device in accordance with the present invention establishes an electrode connection in such a way that a part of the plurality of electrodes serves as detecting electrodes, and a remaining part of the plurality of electrodes serves as screening electrodes and has the same potential as that of the detecting electrodes, the detection sensitivity of the touch panel device at the time when the input means, such as a finger, has a touch therewith can be improved.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a touch panel device in accordance with Embodiment 1 of the present invention;

FIG. 2 is a block diagram showing an input-side switch of the touch panel device in accordance with Embodiment 1 of the present invention;

FIG. 3 is a circuit diagram showing an equivalent circuit when a fingertip approaches or makes a touch with an electrode line of the touch panel device in accordance with Embodiment 1 of the present invention;

FIG. 4 is an explanatory drawing showing a state in which a fingertip approaches to an X-axis electrode line when there is a potential difference between the X-axis electrode line and a Y-axis electrode line of the touch panel device in accordance with Embodiment 1 of the present invention;

FIG. 5 is an explanatory drawing showing a state in which a fingertip approaches to an X-axis electrode line when there is no potential difference between the X-axis electrode line and any Y-axis electrode line of the touch panel device in accordance with Embodiment 1 of the present invention;

FIG. 6 is an explanatory drawing showing a part of a touch panel unit having electrode lines in the shape of a rectangular slice;

FIG. 7 is an explanatory drawing showing a state in which a fingertip approaches a portion in which an X-axis electrode line and a Y-axis electrode line overlap each other in the structure shown in FIG. 6;

FIG. 8 is an explanatory drawing showing a state in which a fingertip does not approach any portion in which an X-axis electrode line and a Y-axis electrode line overlap each other in the structure shown in FIG. 6;

FIG. 9 is an explanatory drawing showing a part of a touch panel unit of a touch panel device in accordance with Embodiment 2 of the present invention;

FIG. 10 is an explanatory drawing showing the details of an overlapped portion in which an X-axis electrode line and a Y-axis electrode line shown in FIG. 9 overlap each other;

FIG. 11 is an explanatory drawing showing a part of another example of the touch panel unit of the touch panel device in accordance with Embodiment 2 of the present invention;

FIG. 12 is a block diagram showing a touch panel device in accordance with Embodiment 3 of the present invention;

FIG. 13 is an explanatory drawing showing a state in which a finger approaches a point just above an X-axis electrode line of the touch panel device in accordance with Embodiment 3 of the present invention;

FIG. 14 is an explanatory drawing schematically showing an amount of voltage reduction of each of X-axis electrode lines which is acquired by an arithmetic circuit in the state shown in FIG. 13;

FIG. 15 is an explanatory drawing showing a state in which a finger approaches a point located midway between two X-axis electrode lines of the touch panel device in accordance with Embodiment 3 of the present invention; and

FIG. 16 is an explanatory drawing schematically showing an amount of voltage reduction of each of X-axis electrode lines which is acquired by an arithmetic circuit in the state shown in FIG. 15.

### DETAILED DESCRIPTION OF THE PREFERRED EMBODIMENTS

### Embodiment 1

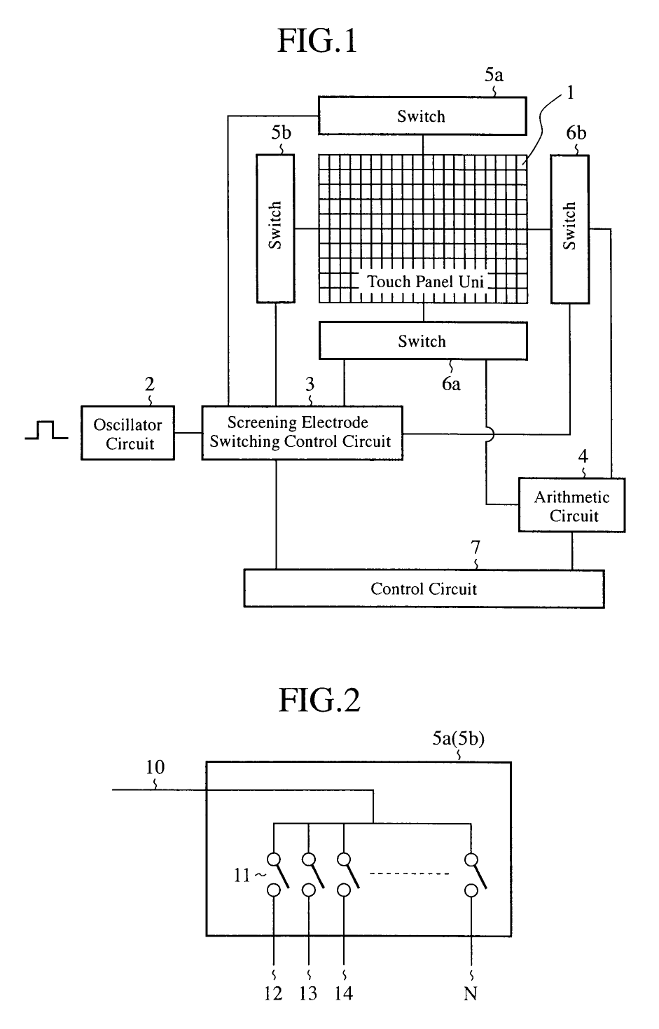

FIG. 1 is a block diagram showing a touch panel device in accordance with Embodiment 1 of the present invention. In the figure, the touch panel device is provided with a touch panel unit 1, an oscillator circuit 2, a screening electrode switching control circuit 3, an arithmetic circuit 4, an X-axis input-side switch 6a, a Y-axis input-side switch 6b, an X-axis output-side switch 6a, a Y-axis output-side switch 6b, and a control circuit 7.

The touch panel unit 1 is used for inputting coordinates and has X-axis electrode lines for detecting the location of an approach or a touch in an X-axis direction and Y-axis electrode lines for detecting the location of the approach or the touch in a Y-axis direction which are arranged in the form of a matrix. The oscillator circuit 2 generates a pulse signal. The screening electrode switching control circuit 3 carries out a switching control operation of dynamically controlling the X-axis and Y-axis electrode lines in the touch panel unit 1 in such a way that the X-axis or Y-axis electrode lines serve as detecting electrodes and the others serve as screening electrodes having the same potential as that of the detecting electrodes.

The arithmetic circuit 4 determines the location of an approach of or a touch by a finger which is an input means by detecting a signal in the electrode lines of the touch panel unit 1. The X-axis input-side switch 5a is used in order to input the pulse signal to the input ends of the X-axis electrode lines, and the Y-axis input-side switch 5b is used in order to input the pulse signal to the input ends of the Y-axis electrode lines. The X-axis output-side switch 6a is used in order to connect the output ends of the X-axis electrode lines to the arithmetic circuit 4, and the Y-axis output-side switch 6b is used in order to connect the output ends of the Y-axis electrode lines to the arithmetic circuit 4. The control circuit 7 controls the whole of the touch panel device.

FIG. 2 is a block diagram showing the details of the X-axis input-side switch 5a (the Y-axis input-side switch 5b). The X-axis input-side switch 5a (the Y-axis input-side switch 5b) is comprised of a connecting line 10 connected to the screening electrode switching control circuit 3, connecting lines 12, 13, 14, . . . , and N respectively connected to the corresponding electrode lines of the touch panel unit 1, and coupling units 11 each for coupling the connecting line 10 with a corresponding one of the connecting lines 12, 13, 14, . . . , and N, and can select one of the corresponding electrode lines of the touch panel unit 1 by switching on only the corresponding one of the coupling units 11 which is connected to the corresponding one of the connecting lines 12, 13, 14, . . . , and N. Each of the X-axis output-side switch 6a and the Y-axis output-side switch 6b has a structure which is reverse to this structure. More specifically, each of the X-axis output-side switch 6a and the Y-axis output-side switch 6b is constructed in such a way as to selectively connect a connecting line connected to one of the corresponding electrode lines of the touch panel unit 1 with a connecting line connected to the arithmetic circuit 4.

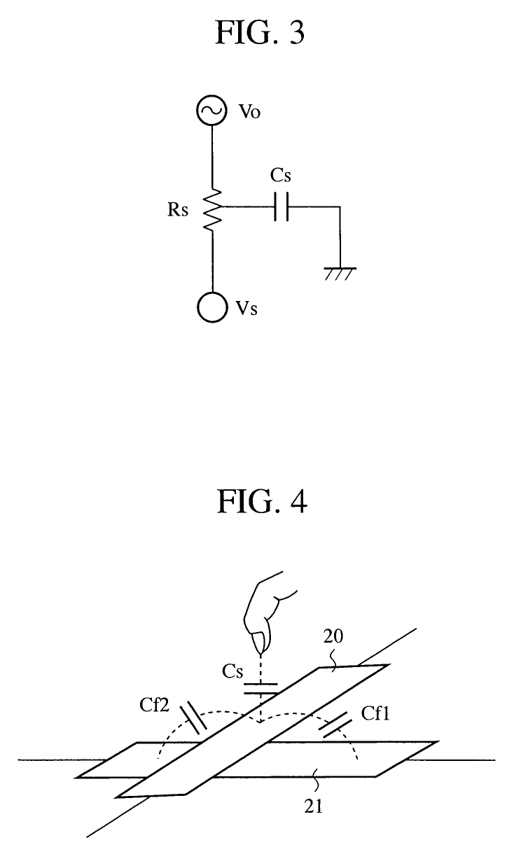

FIG. 3 illustrates an equivalent circuit of the touch panel when a fingertip approaches to or has a touch with an electrode line. In this figure, Vo shows a voltage which is applied to the input end of the electrode line, Rs shows the resistance of the electrode line, Cs shows a capacitance which occurs between the fingertip and the electrode line, and Vs shows a voltage detected at the output end of the electrode line.

FIG. 4 illustrates one (an X-axis electrode line 20) of the X-axis electrode lines, and one (a Y-axis electrode line 21) of the Y-axis electrode lines, and shows a state in which a fingertip approaches to the X-axis electrode line when there is a potential difference between the two electrode lines. In the figure, Cs shows a capacitance which occurs between the X-axis electrode line 20 and the fingertip. Furthermore, Cf1 and Cf2 show capacitances which occur between the X-axis electrode line 20 and the Y-axis electrode line 21.

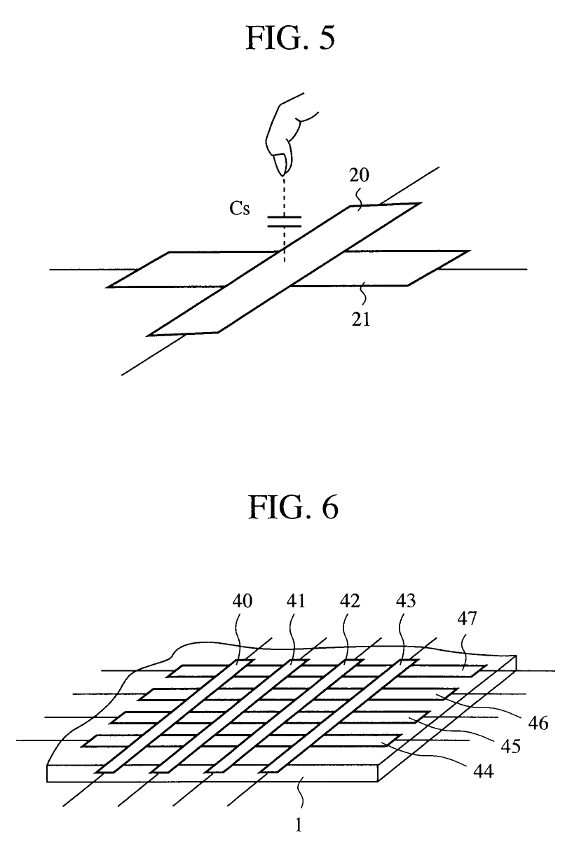

FIG. 5 illustrates one (an X-axis electrode line 20) of the X-axis electrode lines, and one (a Y-axis electrode line 21) of the Y-axis electrode lines, and shows a state in which a fingertip approaches to the X-axis electrode line 20 when there is no potential difference between the two electrode lines. In the figure, Cs shows a capacitance which occurs between the X-axis electrode line 20 and the fingertip.

Next, the operation of the touch panel device in accordance with Embodiment 1 will be explained. Hereafter, the operation of the touch panel device will be explained as to a case in which an operator is bringing his or her finger close to the touch panel unit 1 of FIG. 1. Because the touch panel device operates in the same way even when the operator's fingertip approaches the touch panel unit 1 and even when the operator's fingertip has a touch with the touch panel unit 1, only the case in which the operator's fingertip approaches the touch panel unit 1 will be explained.

In accordance with this embodiment, after detecting the X coordinate location of a fingertip which approaches the touch panel device, the touch panel device detects the Y coordinate location of the fingertip. First, the control circuit 7 instructs the screening electrode switching control circuit 3 to perform a process of detecting the X coordinate location. The screening electrode switching control circuit 3 couples one of the X-axis electrode lines thereto via the X-axis input-side switch 5a disposed at the input ends of the X-axis electrode lines. The screening electrode switching control circuit 3 also couples the output end of the same X-axis electrode line as what is connected thereto via the X-axis input-side switch 5a thereto via the X-axis output-side switch 6a disposed at the output ends of the X-axis electrode lines. More specifically, the X-axis input-side switch 5a couples one of the connecting lines 12, 13, 14, . . . , and N respectively connected to the X-axis electrode lines of the touch panel unit 1 with the connecting line 10 via the corresponding coupling unit 11 according to a command from the screening electrode switching control circuit 3. Furthermore, the X-axis output-side switch 6a couples the electrode line which is connected to the connecting line 10 by the X-axis input-side switch 5a to the connecting line connected to the arithmetic circuit 4. The screening electrode switching control circuit 3 then couples all the Y-axis electrode lines therewith via the Y-axis input-side switch 5b disposed at the input ends of the Y-axis electrode lines.

The screening electrode switching control circuit 3 then applies the pulse signal from the oscillator circuit 2 to the input end of the X-axis electrode line which is coupled therewith via the X-axis input-side switch 5a. More specifically, the screening electrode switching control circuit 3 makes the X-axis electrode line coupled therewith via the X-axis input-side switch 5a serve as a detecting electrode. The screening electrode switching control circuit 3 also applies the same pulse signal as that applied to the detecting electrode to all the Y-axis electrode lines coupled therewith via the Y-axis input-side switch 5b at the same time when the screening electrode switching control circuit 3 applies the pulse signal to the input end of the selected X-axis electrode line. More specifically, the screening electrode switching control circuit makes all the Y-axis electrode lines operate as screening electrodes, and controls them in such a way that all the Y-axis electrode lines have the same potential as the detecting electrode.

The screening electrode switching control circuit 3 applies the pulse signal to each of the plurality of X-axis electrode lines in turn while changing the coupling, via the corresponding connecting line 10, with the corresponding one of the connecting lines 12, 13, 14, . . . , and N within the X-axis input-side switch 5a. At that time, when the operator's fingertip approaches the touch panel unit 1, the fingertip has electrostatic coupling with one X-axis electrode line and a current flows from the X-axis electrode line into the fingertip via this capacitance. The arithmetic circuit 4 determines the voltage at the output end of each of the X-axis electrode lines in turn via the X-axis output-side switch 6a.

Next, the operation of the arithmetic circuit 4 will be explained with reference to FIG. 3. FIG. 3 shows an equivalent circuit in a case in which a finger approaches an X-axis electrode line, as mentioned above. In this case, the resistance of the X-axis electrode line is expressed as Rs, a capacitance which occurs between the finger and the X-axis electrode line is expressed as Cs, and the voltage applied from the oscillator circuit 2 to the input end of the X-axis electrode line is expressed as Vo. When a finger approaches the X-axis electrode line, a current flows into the human body (the ground in the equivalent circuit of FIG. 3) via the capacitance Cs. The arithmetic circuit 4 detects a voltage Vs corresponding to Rs. In this case, because a part of the current which flows into the X-axis electrode line flows into the ground via Cs, the voltage Vs which is detected by the arithmetic circuit 4 is lower than the voltage Vo applied to the input end of the X-axis electrode line. The arithmetic circuit 4 detects the voltage of each X-axis electrode line which is sequentially coupled to the screening electrode switching control circuit 3 via the X-axis input-side switch 5a and which is sequentially coupled to the arithmetic circuit 4 via the X-axis output-side switch 6a so as to determine the reduction in the voltage of each X-axis electrode line, i.e., the difference between Vo and Vs.

Because the capacitance is in inverse proportion to the distance between the fingertip and the X-axis electrode line, the capacitance of the X-axis electrode line which is the nearest to the location where the fingertip approaches becomes the largest. In other words, the current which flows from the X-axis electrode line which is the nearest to the location where the fingertip approaches into the fingertip becomes the largest, and hence the reduction in the voltage of the X-axis electrode line which is detected by the arithmetic circuit 4 becomes the largest. The arithmetic circuit 4 acquires the location of the X-axis electrode line which exhibits the largest amount of voltage reduction among the amounts of voltage reduction of all the X-axis electrode lines which are acquired by the arithmetic circuit, and then defines the acquired location of the X-axis electrode line as the X coordinate location of the fingertip.

After completing the detection of the X coordinate location, the control circuit 7 instructs the screening electrode switching control circuit 3 to carry out a process of detecting the Y coordinate location of the fingertip. The screening electrode switching control circuit 3 couples one of the Y-axis electrode lines therewith via the Y-axis input-side switch 5b disposed at the input ends of the Y-axis electrode lines. The screening electrode switching control circuit 3 also couples the output end of the same Y-axis electrode line as what is coupled therewith via the Y-axis output-side switch 6b disposed at the output ends of the Y-axis electrode lines.

The screening electrode switching control circuit 3 then couples all the X-axis electrode lines therewith via the X-axis input-side switch 5a disposed at the input ends of the X-axis electrode lines. After that, the arithmetic circuit 4 detects the Y coordinate location of the fingertip by performing the same process as that of acquiring the X coordinate location of the fingertip.

Hereafter, the operation of the touch panel device in a case in which the fingertip approaches the X-axis electrode line 20 which is a detecting electrode will be explained with reference to FIGS. 4 and 5. When detecting the X coordinate location of the fingertip, if the Y-axis electrode lines which are not needed for the detection of the X coordinate location are not coupled with the screening electrode switching control circuit via the Y-axis input-side switch 5b, or if the Y-axis electrode lines are grounded in such a way as to have a reference potential, a potential difference occurs between the detecting electrode 20 and the Y-axis electrode line 21 placed in the vicinity of the detecting electrode 20, as shown in FIG. 4. As a result, capacitances (stray capacities) Cf1 and Cf2 occur between these electrodes. At that time, when the fingertip approaches the detecting electrode, a capacitance Cs occurs between the fingertip and the detecting electrode 20. More specifically, the fingertip has electrostatic coupling with the detecting electrode, and the touch panel device enters a state in which the touch panel device is grounded to the human body. As a result, a current flows from the detecting electrode 20 into the fingertip via Cs. The arithmetic circuit 4 detects a reduction in the voltage which is caused by the flow of this current so as to detect the approach of the fingertip, though in the case of FIG. 4 because a current also flows from the detecting electrode 20 into the stray capacities Cf1 and Cf2, the amount of the current which flows into the fingertip becomes small as a result. More specifically, the reduction in the voltage which is caused by the approach of the fingertip becomes small, and this results in a factor to reduce the sensitivity of the detection of the amount of voltage reduction by the arithmetic circuit 4.

In contrast, in accordance with this embodiment, when detecting the X coordinate location of the fingertip, because the screening electrode switching control circuit 3 makes all the Y-axis electrode lines operate as the screening electrodes, the detecting electrode and all the Y-axis electrode lines have the same potential. In this case, as shown in FIG. 5, no capacitance occurs between the X-axis electrode line 20 which is the detecting electrode and the Y-axis electrode line 21 (Cf1 and Cf2 of FIG. 4 do not occur). Also in this embodiment, when a fingertip approaches the detecting electrode, a capacitance Cs occurs between the fingertip and the detecting electrode. More specifically, the fingertip has electrostatic coupling with the detecting electrode, and the touch panel device enters a state where the touch panel device is grounded to the human body. As a result, a current flows from the detecting electrode into the fingertip via Cs. The arithmetic circuit 4 detects a reduction in the voltage which is caused by the flow of this current so as to detect the approach of the fingertip, though because there is no leakage current due to the stray capacities Cf1 and Cf2, unlike in the case of FIG. 4, a larger amount of current flows into the human body through the fingertip as compared with the case of FIG. 4. As a result, the reduction in the voltage which is caused by the approach of the fingertip becomes large, and therefore the sensitivity of the detection of the approach of the fingertip by the arithmetic circuit 4 can be improved.

Thus, the touch panel device in accordance with Embodiment 1, when detecting the X coordinate location of a fingertip approaching thereto, controls all the Y-axis electrode lines which are unrelated to the detecting position of the detection of the X coordinate location in such a way that they operate as screening electrodes, whereas when detecting the Y coordinate location of the fingertip, the touch panel device controls all the X-axis electrode lines which are unrelated to the detecting position of the detection of the Y coordinate location in such a way that they operate as screening electrodes. Therefore, when detecting the location of the fingertip in the X-axis direction, the touch panel device can prevent a current from leaking between the finger and a Y-axis electrode line, and, when detecting the location of the fingertip in the Y-axis direction, the touch panel device can prevent a current from leaking between the finger and an X-axis electrode line. As a result, the touch panel device can improve both the sensitivity of the detection of the X coordinate location and the sensitivity of the detection of the Y coordinate location. Furthermore, because the touch panel device has this structure, it is not necessary to dispose screening electrodes separately in addition to the electrodes in the directions of the X and Y axes and the structure of the device can be simplified.

As mentioned above, the touch panel device in accordance with Embodiment 1 includes: the touch panel unit in which the plurality of electrodes are arranged; the arithmetic circuit for detecting a change in the capacitance of one of the electrodes resulting from an approach or a touch of an input means to or with the touch panel unit, and for detecting the location of the approach or the touch; and the screening electrode switching control circuit for making a part of the plurality of electrodes serve as a detecting electrode and also making another part of the plurality of electrodes as screening electrodes and have the same potential as that of the detecting electrode. Therefore, the touch panel device in accordance with Embodiment 1 can improve the sensitivity of detection of an input means, such as a finger, which approaches thereto or has a touch therewith.

Furthermore, in the touch panel device in accordance with Embodiment 1, the touch panel unit is of matrix type in which the plurality of electrodes consist of electrodes arranged in the direction of the X axis and electrodes arranged in the direction of the Y axis. Therefore, the X-axis electrodes and the Y-axis electrodes can be dynamically controlled in such a way that one X-axis electrode serves as the detecting electrode and all the Y-axis electrodes serve as the screening electrodes, or one Y-axis electrode serves as the detecting electrode and all the X-axis electrodes serve as the screening electrodes.

In addition, in the touch panel device in accordance with Embodiment 1, the screening electrode switching control circuit, when detecting the location of the input means in the direction of the X axis of the touch panel unit, handles one electrode arranged in the direction of the X axis as the detecting electrode and handles the electrodes arranged in the direction of the Y axis as the screening electrodes, whereas, when detecting the location of the input means in the direction of the Y axis of the touch panel unit, the screening electrode switching control circuit handles one electrode arranged in the direction of the Y axis as the detecting electrode and handles the electrodes arranged in the direction of the X axis as the screening electrodes. Therefore, the touch panel device in accordance with Embodiment 1 can improve the accuracy of detection of the X and Y location coordinates of the input means.

### Embodiment 2

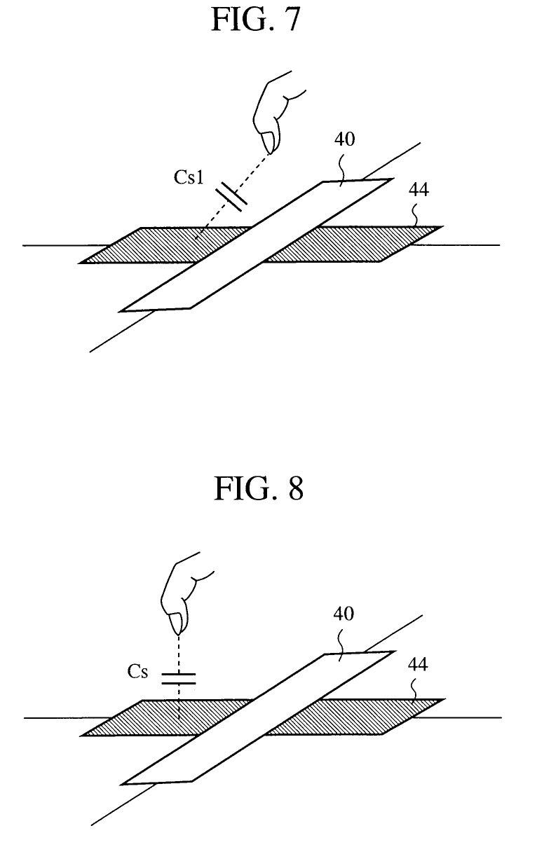

In a touch panel device in accordance with Embodiment 2, X-axis electrode lines and Y-axis electrode lines are formed and arranged in such a way that an area in which each of the X-axis electrode lines and each of the Y-axis electrode lines overlap each other becomes small. Because the structures in terms of drawings of a touch panel unit 1, a screening electrode switching control circuit 3, and an arithmetic circuit 4 of the touch panel device in accordance with Embodiment 2 are the same as those of Embodiment 1, they will be explained with reference to FIG. 1. First, before an explanation is made as to the touch panel device in accordance with Embodiment 2, the electrodes each of which is formed in the shape of a rectangular slice in the touch panel device will be explained. FIG. 6 is an explanatory drawing showing a part of the touch panel unit 1 which has some of the electrode lines each of which is formed in the shape of a rectangular slice. As shown in this figure, each of the X-axis electrode lines 40 to 43 and the Y-axis electrode lines 44 to 47 is formed in the shape of a rectangular slice. Among the electrode lines of the touch panel unit 1 which are constructed in this way, only the X-axis electrode line 40 and the Y-axis electrode line 44 are shown in FIGS. 7 and 8.

FIG. 7 shows a state in which a fingertip approaches a portion in which the X-axis electrode line 40 and the Y-axis electrode line 44 overlap each other, and Cs1 in the figure shows a capacitance which occurs between the fingertip and the Y-axis electrode line 44. FIG. 8 shows a state in which a fingertip approaches a location other than the portion in which the X-axis electrode line 40 and the Y-axis electrode line 44 overlap each other, and Cs in the figure shows a capacitance which occurs between the fingertip and the Y-axis electrode line 44.

In the case in which the electrode lines are configured as shown in FIG. 6, the Y-axis electrode lines 44 to 47 are arranged under the X-axis electrode lines 40 to 43. In this case, for example, when in order to detect the Y coordinate location of a fingertip approaching, the screening electrode switching control circuit 3 controls to handle the Y-axis electrode line 44 as a detecting electrode, and also controls to handle all the X-axis electrode lines, i.e., the X-axis electrode lines 40 to 43 as screening electrodes, the touch panel is placed in a state in which, in a portion in which the Y-axis electrode line 44 which is a detecting electrode and each of the X-axis electrode lines 40 to 43 which are screening electrodes overlap each other, the screening electrode is placed above the Y-axis electrode line 44. In this case, when a fingertip approaches the overlapped portion of the Y-axis electrode line 44 and the screening electrode, the sensitivity of detection of a reduction in the voltage which is caused by the approach of the fingertip degrades in the arithmetic circuit 4.

This degradation in the detection sensitivity will be concretely explained with reference to FIGS. 7 and 8. When the X-axis electrode line 40 is made to operate as a screening electrode and the Y-axis electrode line 44 is made to operate as a detecting electrode, a capacitance occurs between the fingertip and the Y-axis electrode line 44 which is a detecting electrode. In the case of FIG. 7, i.e., in a case in which a fingertip approaches the overlapped portion of the X-axis electrode line 40 which is a screening electrode and the Y-axis electrode line 44 which is a detecting electrode, the capacitance which occurs between the fingertip and the detecting electrode is illustrated as Cs1. In contrast, in the case of FIG. 8, i.e., in a case in which a fingertip approaches a location other than the overlapped portion of the X-axis electrode line 40 which is a screening electrode and the Y-axis electrode line 44 which is a detecting electrode, the capacitance which occurs between the fingertip and the detecting electrode is illustrated as Cs.

When viewed from the Y-axis electrode line 44 which is a detecting electrode, it is clear that the distance between the fingertip and the detecting electrode in the case of FIG. 7, i.e., in the case in which the fingertip approaches the overlapped portion of the X-axis electrode line 40 which is a screening electrode and the Y-axis electrode line 44 which is a detecting electrode is longer than that in the case of FIG. 8, i.e., in the case in which the fingertip approaches a location other than the overlapped portion of the X-axis electrode line 40 which is a screening electrode and the Y-axis electrode line 44 which is a detecting electrode. In general, the capacitance is in inverse proportion to the distance between the fingertip and the detecting electrode. Therefore, in the case in which the fingertip approaches the overlapped portion of the X-axis electrode line 40 which is a screening electrode and the Y-axis electrode line 44 which is a detecting electrode, the capacitance which occurs between the fingertip and the Y-axis electrode line 44 which is a detecting electrode becomes small, and therefore the sensitivity of detection of a reduction in the voltage which is caused by the approach of the fingertip degrades in the arithmetic circuit 4.

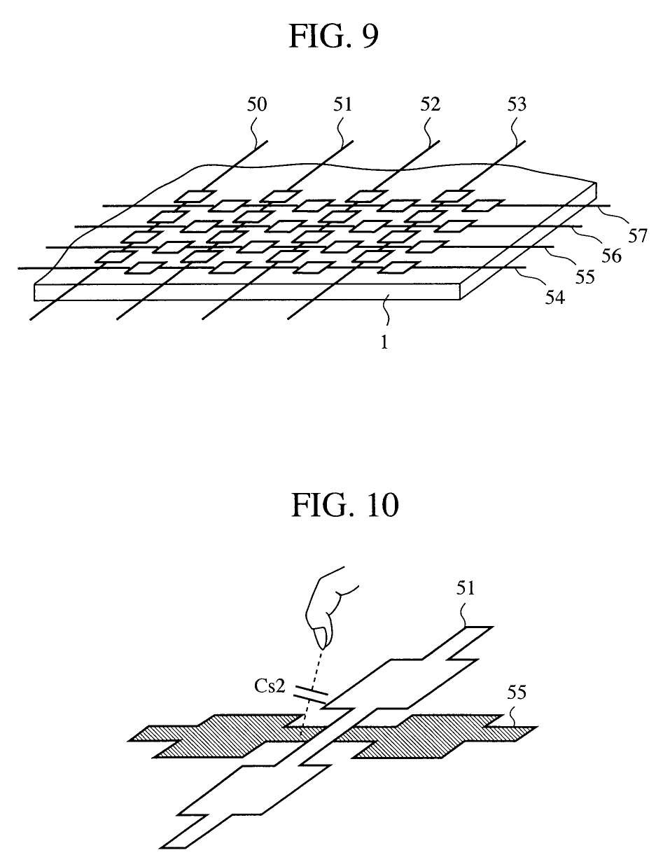

In order to prevent such reduction in the detection sensitivity, the touch panel device in accordance with this Embodiment 2 has the following structure. FIG. 9 shows some of the electrode lines which are arranged in the touch panel unit 1 in accordance with Embodiment 2. In this example, the region in which each of the X-axis electrode lines and each of the Y-axis electrode lines overlap each other is formed in such a way as to be shaped to have a small area. More specifically, the X-axis electrode lines 50 to 53 and the Y-axis electrode lines 54 to 57 shown in FIG. 9 are formed and arranged in such a way that the area in which each of the X-axis electrode lines 50 to 53 and each of the Y-axis electrode lines 54 to 57 overlap each other becomes small. FIG. 10 shows the details of the portion in which the X-axis electrode line 51 and the Y-axis electrode line 55 shown in FIG. 9 overlap each other, and Cs2 shows a capacitance which occurs between a fingertip approaching and the Y-axis electrode line 55.

In the case of the electrode shape of Embodiment 2 as shown in FIGS. 9 and 10, i.e., in the case in which the area in which each of the X-axis electrode lines 50 to 53 and each of the Y-axis electrode lines 54 to 57 overlap each other becomes smaller than that in the case, as shown in FIG. 6, in which each of the X-axis and Y-axis electrode lines is formed in the shape of a rectangular slice, because the portion in which the Y-axis electrode line 54 which is a detecting electrode and each of the X-axis electrode lines 50 to 53 which are screening electrodes overlap each is small even when in order to, for example, detect the Y coordinate location of a fingertip approaching, the screening electrode switching control circuit 3 controls to handle the Y-axis electrode line 54 as a detecting electrode, and also controls to handle all the X-axis electrode lines, i.e., the X-axis electrode lines 50 to 53 as screening electrodes, the distance between the fingertip and the detecting electrode becomes smaller than that in the case in which each of the X-axis and Y-axis electrode lines is formed in the shape of a rectangular slice even though the fingertip approaches the overlapped portion of the detecting electrode and a screening electrode.

As shown in FIG. 10 in detail, because the X-axis electrode line 51 and the Y-axis electrode line 55 are formed in such a way that in the portion in which they overlap each other, their widths become small, the distance between the fingertip and the Y-axis electrode line 55 which is a detecting electrode becomes smaller than that in the case of FIG. 7. Therefore, the capacitance Cs2 becomes larger than the capacitance Cs1, and hence the amount of voltage reduction detected by the arithmetic circuit 4 in the case of FIG. 10 becomes larger than that in the case of FIG. 7. Thus, the bad influence of the overlapped portion which is caused by making each X-axis electrode line as a screening electrode when detecting the Y coordinate location of a fingertip approaching can be suppressed, and therefore the reduction in the detection sensitivity can be suppressed.

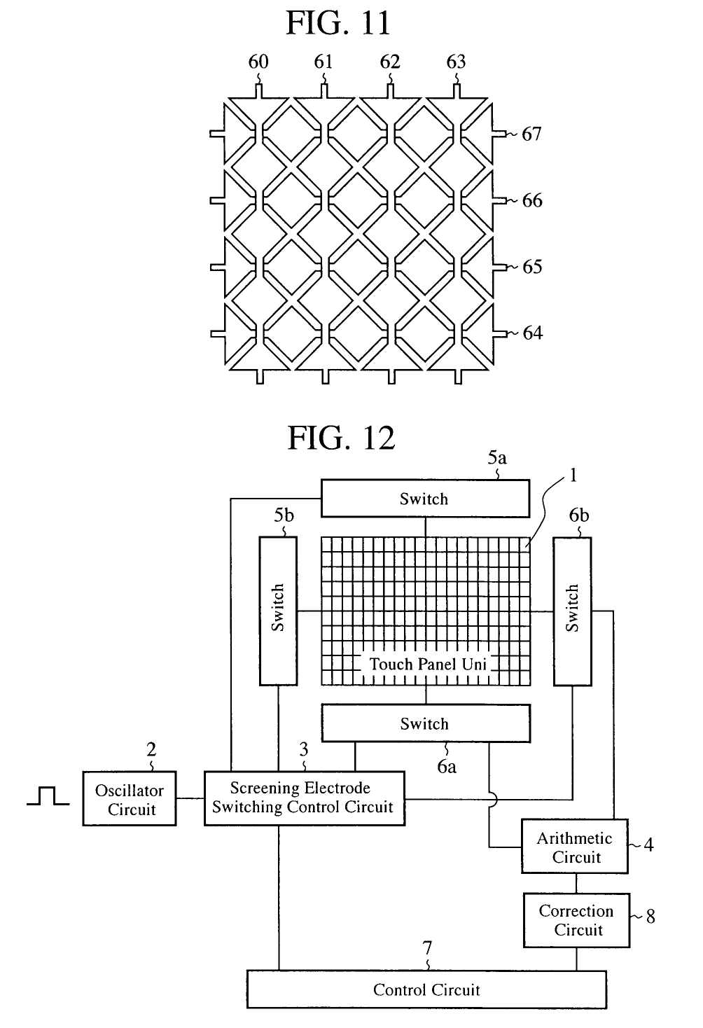

FIG. 11 is a block diagram showing another example of Embodiment 2. FIG. 11 shows only the structures of the X-axis and Y-axis electrode lines. In this example, the X-axis and Y-axis electrode lines are formed in such a way that in the portion in which each of the X-axis electrode lines and each of the Y-axis electrode lines overlap each other, their widths become small, and each of remaining parts of each of the X-axis and Y-axis electrode lines is shaped like a side of a rhombus (each remaining part of each of the electrode lines arranged in the edges of the touch panel is shaped like a side of a triangle which is a half of the rhombus). More specifically, in the structure of FIG. 11, the X-axis electrode lines 60 to 63 and the Y-axis electrode lines 64 to 67 are formed in such a way that each of them is shaped into a series of a plurality of rhombuses, and are arranged so that each of the X-axis electrode lines 60 to 63 and each of the Y-axis electrode lines 64 to 67 overlap each other at a connecting point at which two adjacent rhombuses are connected in each of the X-axis electrode lines 60 to 63 and in each of the Y-axis electrode lines 64 to 67. This structure can increase the size of any portion of each electrode line other than the overlapped portions, and can therefore suppress the bad influence of the overlapped portions of each electrode line. Furthermore, the above-mentioned structure can increase the area of any portion of each electrode line other than the overlapped portions, and can therefore improve the sensitivity of detection of a fingertip which is approaching the touch panel or which has a touch with the touch panel.

In this Embodiment 2, any portion of each electrode line other than the overlapped portions is formed in the shape of a square or a rhombus, as mentioned above. As an alternative, any portion of each of the X-axis and Y-axis electrode lines other than the overlapped portions can be formed in a shape other than the above-mentioned shape as long as the X-axis and Y-axis electrode lines are formed and arranged in such a way that the overlapped portion in which each of the X-axis electrode lines and each of the Y-axis electrode lines becomes small. It cannot be overemphasized that this variant offers the same advantages.

Because the electrode lines disposed in the touch panel unit 1 are thus formed and arranged in such a way that the overlapped portion in which each of the X-axis electrode lines and each of the Y-axis electrode lines becomes small, even when, in the electrode lines arranged in the form of a matrix, each electrode line which is placed at a lower side is made to operate as a detecting electrode and the electrode lines which are placed at an upper side are made to operate as screening electrodes, the reduction of the detection sensitivity can be suppressed and the accuracy of detection of the X and Y location coordinates of an input means such as a fingertip can be improved.

As mentioned above, in the touch panel device in accordance with Embodiment 2, because the electrode lines disposed in the touch panel unit 1 are formed and arranged in such a way that the overlapped portion in which each of the X-axis electrode lines and each of the Y-axis electrode lines becomes small, the reduction of the detection sensitivity can be suppressed and therefore the accuracy of detection of the X and Y location coordinates of an input means such as a fingertip can be improved.

### Embodiment 3

A touch panel device in accordance with Embodiment 3 includes a correction circuit for correcting an amount of change in the capacitance of each detecting electrode on the basis of an electrode connection which is established by a screening electrode switching control circuit, and detects the location of an approach or a touch of a fingertip. FIG. 12 is a block diagram showing the touch panel device in accordance with Embodiment 3. The touch panel device shown in the figure is provided with a touch panel unit 1, an oscillator circuit 2, the screening electrode switching control circuit 3, an arithmetic circuit 4, an X-axis input-side switch 5a, a Y-axis input-side switch 5b, an X-axis output-side switch 6a, a Y-axis output-side switch 6b, a control circuit 7, and the correction circuit 8. Because the structures of the touch panel unit 1, . . . ,and the control circuit 7 are the same as those of Embodiment 1 or 2, the explanation of the components will be omitted hereafter. The correction circuit 8 is constructed in such a way as to correct an amount of reduction in the voltage of each of the X-axis and Y-axis electrode lines on the basis of the reduction in the voltage of each of the electrode lines which is acquired by the arithmetic circuit 4.

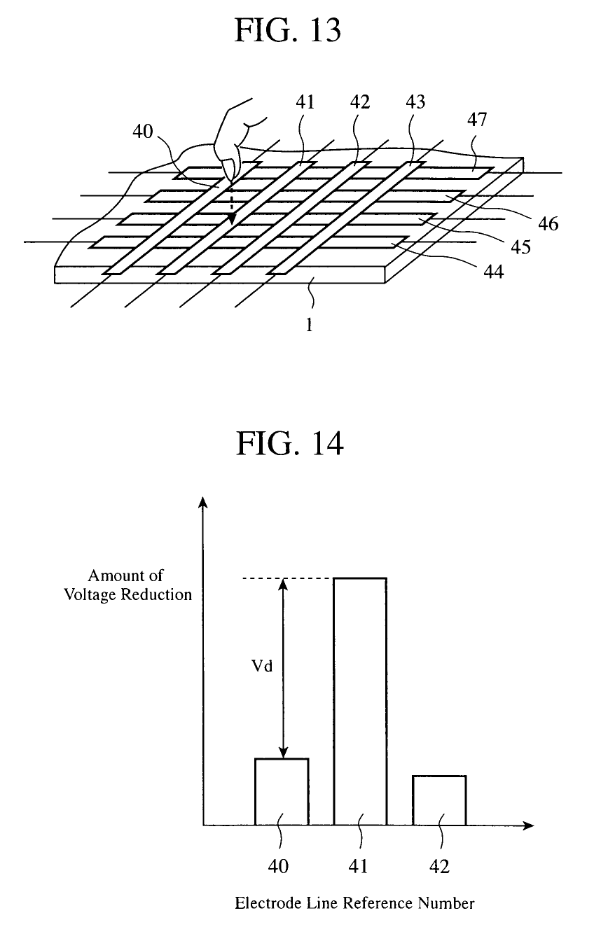

Next, the operation of the touch panel device in accordance with Embodiment 3 will be explained. FIG. 13 is a diagram showing a state in which a finger approaches the electrode lines which are arranged in the touch panel unit 1 in the same way as that shown in FIG. 6, and shows a case in which an operator approaches his or her finger right above an X-axis electrode line 41. FIG. 14 is an explanatory drawing schematically showing the reduction in the voltage of each of the X-axis electrode lines 40, 41, and 42 which is acquired by the arithmetic circuit 4 in the state shown in FIG. 13.

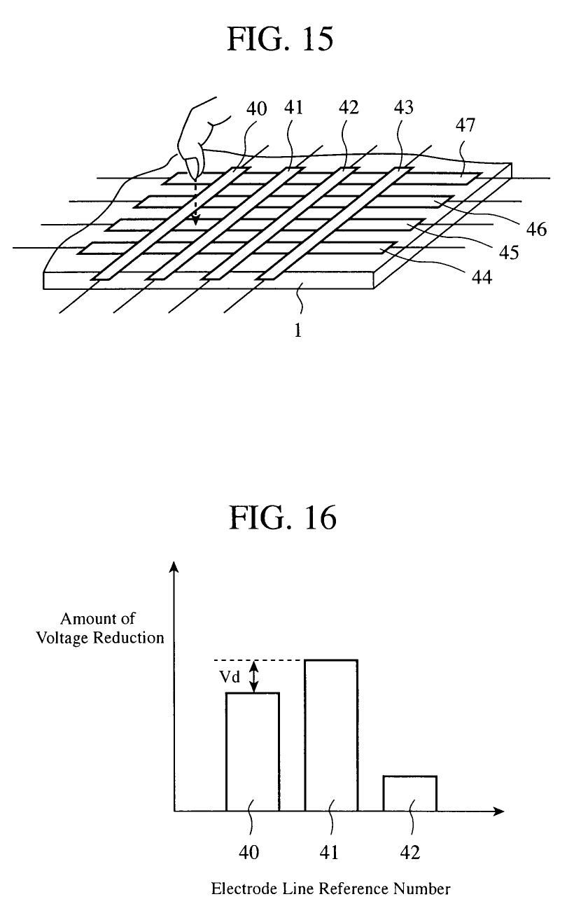

FIG. 15 is a diagram showing a state in which a finger is approaching the electrode lines which are arranged in the touch panel unit 1 in the same way as that shown in FIG. 6, and shows a case in which an operator approaches his or her finger toward a point located midway between the X-axis electrode lines 40 and 41. FIG. 16 is an explanatory drawing schematically showing the reduction in the voltage of each of the X-axis electrode lines 40, 41, and 42 which is acquired by the arithmetic circuit 4 in the state shown in FIG. 15.

When an operator approaches his or her finger toward the touch panel unit 1 of FIG. 12, the arithmetic circuit 4 detects the locations of X-axis and Y-axis electrode lines toward which the finger approaches by carrying out the same processing as that shown in Embodiment 1. However, in the case in which the electrode lines of the touch panel unit 1 have the structure as shown in FIG. 6, as explained in Embodiment 2, each of the X-axis electrode lines is placed on each of the Y-axis electrode lines at the overlapped portion at which they overlap each other, and, when a fingertip approaches this overlapped portion, there is a possibility that the sensitivity of the detection of the amount of voltage reduction of the Y-axis electrode line degrades in the arithmetic circuit 4. Therefore, the arithmetic circuit 4 outputs the acquired value to the correction circuit 8, and the correction circuit 8, when determining that a fingertip approaches the overlapped portion of the X-axis electrode line and the Y-axis electrode line, corrects the amount of voltage reduction of the Y-axis electrode line which is acquired by the arithmetic circuit 4.

For example, the correction circuit 8 makes the correction of the amount of voltage reduction as follows. Hereafter, the amount of voltage reduction acquired by the arithmetic circuit 4 is expressed as Va in a case in which a fingertip approaches a portion in which any X-axis electrode line does not overlap any Y-axis electrode line, and the amount of voltage reduction acquired by the arithmetic circuit 4 is expressed as Vb in a case in which a fingertip approaches an overlapped portion in which an X-axis electrode line and a Y-axis electrode line overlap each other. These Va and Vb can be experimentally determined beforehand. In this case, when a fingertip approaches the overlapped portion of an X-axis electrode line and a Y-axis electrode line, the correction circuit 8 corrects the amount of voltage reduction of the Y-axis electrode line which is acquired by the arithmetic circuit 4 in such a way that the amount of the voltage reduction gets close to that in the case in which a fingertip approaches a portion in which any X-axis electrode line does not overlap any Y-axis electrode line. Concretely, when the yet-to-be-corrected amount of voltage reduction is expressed as V and the corrected amount of voltage reduction is expressed as V′, the correction circuit 8 corrects the amount of the voltage reduction according to, for example, the following equation:

V′=V×(Va/Vb)

The correction circuit 8 can implement the judgment of whether or not a fingertip approaches the overlapped portion of an X-axis electrode line and a Y-axis electrode line as follows. The correction circuit 8 judges whether or not a fingertip approaches a point just above an X-axis electrode line from the amount of voltage reduction of each X-axis electrode line which is acquired by the arithmetic circuit 4 so as to judge whether or not the fingertip approaches the overlapped portion of an X-axis electrode line and a Y-axis electrode line.

The process of judging whether or not a fingertip approaches a point just above an X-axis electrode line will be explained with reference to FIGS. 13 to 16. Hereafter, a case in which a fingertip approaches a point just above an X-axis electrode line 41, as shown in FIG. 13, will be considered. In this case, the amount of voltage reduction of each X-axis electrode line which is acquired by the arithmetic circuit 4 is as shown in a graph of FIG. 14. More specifically, the amount of voltage reduction of the X-axis electrode line 41 just to the top of which the fingertip approaches is the largest, whereas the amount of voltage reduction of each of the X-axis electrode lines 40 and 42 in the vicinity of the X-axis electrode line 41 (i.e., the neighboring X-axis electrode lines) becomes smaller than the amount of voltage reduction of the X-axis electrode line 41. Next, a case in which a fingertip approaches not a point just above the X-axis electrode line 41, but a point located midway between the X-axis electrode line 40 and the X-axis electrode line 41, as shown in FIG. 15, will be considered. In this case, the amount of voltage reduction of each X-axis electrode line which is acquired by the arithmetic circuit 4 is as shown in a graph of FIG. 16. More specifically, because the location of the fingertip is similarly close to both the X-axis electrode line 40 and the X-axis electrode line 41, the difference between the amount of voltage reduction of the X-axis electrode line 40 and that of the X-axis electrode line 41 becomes smaller than that in the case of FIG. 13.

The correction circuit 8 determines the difference (Vd in FIGS. 14 and 16) between the largest one of the amounts of voltage reduction of the X-axis electrode lines which are acquired by the arithmetic circuit 4, and the larger one of the amounts of voltage reduction of the neighboring X-axis electrode lines which are adjacent to the X-axis electrode line having the largest amount of voltage reduction. When this voltage reduction difference Vd is larger than a fixed threshold Vdth, the correction circuit 8 judges that a fingertip approaches a point just above the X-axis electrode line having the largest amount of voltage reduction, i.e., that the fingertip approaches an overlapped portion at which the X-axis electrode line and a Y-axis electrode line overlap each other. The above-mentioned fixed threshold Vdth is predetermined experimentally from the amounts of voltage reduction of the X-axis electrode lines in a state in which a fingertip is made to approach a point just above an X-axis electrode line.

Next, the voltage which is thus corrected by the correction circuit 8 is sent out to the arithmetic circuit 4, and the arithmetic circuit 4 performs detection of the coordinates of the approach in the directions of the X axis and the Y axis on the basis of the corrected voltage, as explained in Embodiment 1.

By making the correction circuit 8 operate as mentioned above, when a fingertip approaches the overlapped portion of an X-axis electrode line and a Y-axis electrode line, the touch panel device makes it possible to correct the amount of voltage reduction of the Y-axis electrode line which is acquired by the arithmetic circuit 4, and to suppress the reduction of the detection sensitivity which is caused by the overlap between the electrode lines.

This Embodiment 3 is applied to the case in which the X-axis electrode lines are arranged above the Y-axis electrode lines, as previously explained, though Embodiment 3 can be also applied to a case in which the X-axis electrode lines are arranged above the Y-axis electrode lines. In this case, when a fingertip approaches the overlapped portion of an X-axis electrode line and a Y-axis electrode line, the correction circuit 8 corrects a reduction in the voltage which appears in the X-axis electrode line placed on a lower side. Furthermore, in this Embodiment 3, the case in which this embodiment is applied to Embodiment 1 is explained, though this embodiment can be alternatively combined with Embodiment 2.

As mentioned above, the touch panel device in accordance with Embodiment 3 includes the correction circuit for correcting the amount of change in the capacitance of the detecting electrode on the basis of the electrode connection which is established by the screening electrode switching control circuit, and the arithmetic circuit detects the location of an approach or a touch on the basis of the corrected value obtained by the correction circuit. Therefore, the touch panel device can suppress the reduction in the detection sensitivity which is caused by the overlap of the electrode lines, and can improve the accuracy of the detection of the location of an approach or a touch.

The touch panel device in accordance with any of above-mentioned Embodiments 1 to 3 detects the change in the capacitance of the detecting electrode at the time when a fingertip approaches by converting the change into an amount of voltage reduction. By alternatively using another method, such as a method of directly detecting a reduction in the current, or a method of using, as an index, the length of time required to charge according to the capacitance, the touch panel device can detect the change in the capacitance of the detecting electrode.

Many widely different embodiments of the present invention may be constructed without departing from the spirit and scope of the present invention. It should be understood that the present invention is not limited to the specific embodiments described in the specification, except as defined in the appended claims.

What is claimed is:

1. A touch panel device comprising:
a touch panel unit in which a plurality of electrodes are arranged;
an arithmetic circuit for detecting a change in capacitance of one of the electrodes resulting from an approach or a touch of an input means to or with said touch panel unit, and detects a location of said approach or said touch;
a screening electrode switching control circuit for establishing an electrode connection in such a way that a part of said plurality of electrodes serves as detecting electrodes, and a remaining part of said plurality of electrodes serves as screening electrodes and has a same potential as that of said detecting electrodes.

2. The touch panel device according to claim 1, wherein said touch panel unit is of matrix type in which said plurality of electrodes include electrodes arranged in a direction of an X axis and electrodes arranged in a direction of a Y axis.

3. The touch panel device according to claim 2, wherein said screening electrode switching control circuit handles each of the electrodes arranged in the direction of the X axis as the detecting electrode and handles the electrodes arranged in the direction of the Y axis as the screening electrodes when detecting the location of said approach or said touch to or with said touch panel unit in the direction of the X axis, whereas said screening electrode switching control circuit handles the electrodes arranged in the direction of the X axis as the screening electrodes and handles each of the electrodes arranged in the direction of the Y axis as the detecting electrode when detecting the location of said approach or said touch to or with said touch panel unit in the direction of the Y axis.

4. The touch panel device according to claim 3, wherein the plurality of electrodes arranged in said touch panel unit are arranged in such a way that an area in which each of the electrodes arranged in the direction of the X axis and each of the electrodes arranged in the direction of the Y axis overlap each other becomes small.

5. The touch panel device according to claim 1, wherein said touch panel device has a correction circuit for correcting an amount of change in capacitance of a detecting electrode on a basis of the electrode connection established by said screening electrode switching control circuit, and said arithmetic circuit detects the location of the approach or the touch on a basis of the amount of change corrected by said correction circuit.

6. The touch panel device according to claim 2, wherein said touch panel device has a correction circuit for correcting an amount of change in capacitance of a detecting electrode on a basis of the electrode connection established by said screening electrode switching control circuit, and said arithmetic circuit detects the location of the approach or the touch on a basis of the amount of change corrected by said correction circuit.

7. The touch panel device according to claim 3, wherein said touch panel device has a correction circuit for correcting an amount of change in capacitance of a detecting electrode on a basis of the electrode connection established by said screening electrode switching control circuit, and said arithmetic circuit detects the location of the approach or the touch on a basis of the amount of change corrected by said correction circuit.

8. The touch panel device according to claim 4, wherein said touch panel device has a correction circuit for correcting an amount of change in capacitance of a detecting electrode on a basis of the electrode connection established by said screening electrode switching control circuit, and said arithmetic circuit detects the location of the approach or the touch on a basis of the amount of change corrected by said correction circuit.
